(19) United States
(12) Patent Application Publication
(10) Pub. No.: US 2008/0060507 A1
(43) Pub. Date: Mar. 13, 2008

(54) Versatile electronic sheet music device with improved navigation system and method

(76) Inventor: Helmut Welchering, Jackson Heights, NY (US)

Correspondence Address: Steven Horowitz;Counselor at Law, Suite 700, 295 Madison Avenue, New York, NY, 10017, US

(21) Appl. No.: 11/516,870

(22) Filed: Sep. 7, 2006

(51) Int. Cl. G10H 7/00

(52) U.S. Cl. 84/645

(57) ABSTRACT

A versatile electronic sheet music device with an improved navigation system, comprising a memory having a storage of all musical scores and of an index of said musical scores. The device comprises a wide angle visibility display. The display is capable of displaying the notes arranged by musical bar and/or by page. A central processing unit receives information from an input device and from a foot actuated input device, touch-screen, and/or a microphone, processes said information and communicates the output information to the display. The foot actuated input device is capable of communicating to the central processing unit an identity of any musical bar and/or any page of the notes of the musical score. The foot actuator comprises at least one pedal that allows selection of any of at least ten characters, an “Enter” input signal and a mode selection. The commands and outputs are processed by software.

### FIELD OF THE INVENTION

The field of this invention is electronic sheet music devices, and particularly an electronic sheet music device with improved navigation system.

### BACKGROUND OF THE INVENTION AND DISCUSSION OF THE PRIOR ART

Throughout the history of recorded music, thick, worn piles of sheet music have always been musician's constant companions and lifelong friends and enemies.

Many sheets of music accompany musicians from early childhood throughout musician's entire life. As sheet music lives, works, travels, plays and often dines alongside its owner, it loses its youthful luster. Individual pages begin to fall out of the binding. The paper turns yellow, stains, rips. The once-crisp black print fades into gray shadows, forcing the performer to strain his vision and divert attention from his service to the muse.

Paper sheet music takes up space. Lots of space: boxes, hallways of space. The older, the more distinguished the musician becomes, the wider his repertoire expands, the taller the stack of boxes grows in his apartment.

Paper sheet music gets lost. It gets lost inside the storage boxes and cardboards. It slips out of pockets. It gets left behind on theater stages and on subway seats. Even if it is not physically lost, it sometimes takes hours for musicians to find the right notebook that has the musical piece to be performed.

Paper sheet music is heavy. It lies as a heavy burden on the shoulders of a traveling musician. It is not uncommon to see a musician setting off on extended performing tour in the airport, who is lugging around tremendous packages of notes in one hand and a contrabass in another. As safety of sheet music is essential for the tour and, often performer's entire career, it can not be sent off with another luggage. Instead, the large precious package must be taken into the cabin of the plane as a carry-on to accompany the performer on his 24-hour flight from New York to Sydney.

Once the precious heavy load of sheet music is hand-delivered for performance at Sydney Opera, its disadvantages over the object of present invention continue to show. One particular disadvantage of sheet music is the necessity to turn pages. This mechanical task requires the musician to mentally and physically disrupt the flow of his performance, to change his playing position by extending a hand and manually turning a page of an old notebook. Care must be taken not to jerk on the sheets while turning them in the passion of Paganini's Caprice. Otherwise the page can be ripped. If some pages are already loose, as they often are, one may unexpectedly fall out in the middle of the performance, creating an awkward situation for solo performer or embarrassment for the entire orchestra.

During the concerto, the use of paper sheet notes wastes performer's and audience's time. When conductor tells orchestra to go to a certain bar, the rustling of pages ensues and lasts until everyone is literally “on the same page”. This break for turning of the pages has always been an unpleasant, but necessary disruption for audience and musicians alike.

The rustling sound that paper sheet notes make is unpleasant to hear during a concerto, especially if it occurs near the microphone and transmitted to the amplifier. Such a sound can be disastrous for performers during recording sessions. When a musical piece is recorded for use on CDs, absolute silence is required during performance. Often tens of takes/performances are required to record the one that is perfect. So, whenever during the twentieth take, one of the members of a hundred-man orchestra accidentally rustles with his sheet music or creaks with his chair in a move to turn a page, the frustration of entire group is focused at him.

With increasing proliferation of monitors and computers, some attempts have been made to do away with sheet music in favor of the digitally-displayed musical notes. The main advantage of these systems is allowing the musician to keep their hands free so that they can use their hands to play the music. To this end, foot pedals are known. However, these prior art solutions do not provide adequate navigation systems and have other disadvantages.

For example, U.S. Pat. No. 5,760,323 discusses networked electronic music display stands, wherein the turning of electronic pages is accomplished with the use of a remote mechanical actuator. The actuator can “flip” digital pages forwards and backwards, in continuous fashion, one page at a time. If a conductor unexpectedly orders his orchestra to go from page one to page fifty, the orchestra would begin the exercise routine of 49 actuations, with noise, exertion, and distraction far exceeding those associated with paper sheets. U.S. Pat. No. 6,809,246 B2 allows the user to program the performance sequence into the device. Thus, if the performer knows in advance that after page one, page fifty will be played, he can program the device to open page 50 right after page one. But the problem with this approach is that sequence to be played must be known in advance. While the playing sequence is usually known for concerts, sometimes performances take unexpected turns. Furthermore, rehearsals, even for best orchestras, can be erratic, requiring constant jumping throughout the composition to polish out rough or difficult passages. Prior art offers no fast and intuitive way to jump to a particular odd page, or to a particular bar of the composition that is just as good or better than that provided by traditional sheet music. There is also no indexing system in the prior art that would allow to easily select the composition by author or the musical composition.

Accordingly, the navigation described in prior art patents is less than satisfactory for professional use for several reasons. First, they do not entirely eliminate the need for use of the hands. Second, they do not provide for easy and unexpected accessibility to any bar in a music score. Third, they cannot easily be used outdoors. Fourth, they do not effectively index the music for the musician.

Furthermore, prior art electronic music displays are generally only useful indoors or at night. Light reflecting off the screen and limited visibility angle of some displays limit the use of such devices outside during the day. Small screen sizes and limited height and monitor rotation adjustment options are also among the drawbacks of the prior art. Limited storage options and limited access to electronic sheet music files is another limitation. Most prior art devices are limited to displaying the files stored in their memory and are not designed for easy on-the-fly, wireless access to internet music databases for downloading electronic sheet music.

In light of the problems associated with traditional sheet music and limitations associated with prior art devices, there is a long-standing and unsatisfied need in the art for a device that provides permanency and convenience of digital display and storage, while retaining easy intuitive and quick navigation and crisp, clear visibility in any light. Such device must be lightweight, and conveniently shaped for travel and storage, while providing the necessary rigidity for stationary use. It must be versatile in use, accepting various media and providing easy universal connectivity to other accessories and the internet. It must be able to become a true lifelong friend, companion and tireless assistant to the musician. The present invention achieves all of these objectives and provides numerous additional benefits.

### SUMMARY OF THE PRESENT INVENTION

The versatile electronic sheet music device of the present invention improves upon existing paper sheet music and electronic sheet music devices. One particular advancement, among many, is in the area of navigation.

The device comprises central processing unit, a memory device, display having input device associated therewith, foot actuator and software. The memory that is used for storage of all musical scores that a musician needs to perform. Memory also stores an index of musical scores. This index cross-references a simple code with a particular composer and a particular musical score by said composer.

The device further comprises a wide angle visibility display. This display allows effective visibility outdoors. The display is capable of displaying the notes of a musical score. These notes can be arranged either by musical bar and/or by page. An input device capable of inputting the simple code defining the musical score is associated with the display device.

A central processing unit (CPU) receives information from an input device and from a foot actuator, touch-screen, and/or a microphone. The CPU processes said information according to the software program and communicates the output information to the display. The processing time after the command is entered and before the results of the request are displayed is almost imperceptible to the user.

The versatile electronic sheet music device further comprises a foot actuated input device capable of communicating input to the central processing unit. The foot actuated input device comprises at least one pedal. The at least one pedal allows inputting of any of at least ten characters, an “Enter” input signal and a “Mode” selection. The input consists of a simple code identifying a musical score and its composer. The input code may also identify a musical bar and/or any page of the notes of the musical score. The “Mode” selection allows for choosing between a bar mode and a page mode. The pedals are designed and positioned to be comfortably operable by two feet of a person.

Among the variety of input devices that can be used with versatile electronic sheet music device are a touch screen and a microphone. The microphone is part of the voice recognition system for recognizing musician's oral pronunciation of the names of composers, musical pieces and bar numbers, as well as codes and subcodes, identifying a musical piece.

The versatility of the device is further enhanced by wireless and wired internet access capability.

### IMPORTANT OBJECTS AND ADVANTAGES

The following are important objects and advantages of the present invention:

(1) To provide an electronic sheet music device and method that is versatile;

(2) To provide an electronic sheet music device and method that allows the musician to quickly and easily navigate to and display any commonly used subpart of a musical piece;

(3) To provide an electronic sheet music device and method that allows easy and instant access to any musical bar of a musical score;

(4) To provide an electronic sheet music device and method that allows easy and instant access to any page of a musical score;

(5) To provide an electronic sheet music device and method that is operable conveniently without using the musician's hands to flip through sheet music and without using the musician's hands to control the device in any other way;

(6) To provide an electronic sheet music device and method that is ideally suited for and specifically designed for use in the context of an orchestra receiving instructions from a conductor during recordings and rehearsals;

(7) To provide an electronic sheet music device and method that provides a simple and intuitive navigation system for a musical score that gives the user both the option of instantly access any page or musical bar as well as scrolling consecutively through the various pages, bars or other subparts of the musical score;

(8) To provide such an electronic sheet music device and method that affords navigation through a musical piece by voice input;

(9) To provide an electronic sheet music device and method that allows simple and intuitive navigation within a musical piece displayed on a monitor by saying or otherwise entering a bar number;

(10) To provide an electronic sheet music device and method that minimizes disruptions to a musician during performance;

(11) To provide an electronic sheet music device and method that minimizes noise associated with navigation, for example for navigation through sheet music;

(12) To provide an electronic sheet music device and method that allows for storage of large database of music scores;

(13) To provide an electronic sheet music device and method that allows wired and wireless access to internet music databases for retrieval of sheet music files for instant display or addition to onboard music database;

(14) To provide an electronic sheet music device and method that is easy to see under all lighting conditions including outdoors and in the sunlight;

(15) To provide an electronic sheet music device and method that can provide permanent deterioration-free storage for digitized sheet music;

(16) To provide an electronic sheet music device and method that is portable and easy to store and transport;

(17) To provide an electronic sheet music device and method with variable and expandable display options;

(18) To provide an electronic sheet music device and method that can read and display sheet music in a variety of formats from a variety of input sources;

(19) To provide an electronic sheet music device and method that is designed specifically to be used by musicians of any height; and

(20) To provide an electronic sheet music device and method that is designed specifically to be used by musicians in any sitting position.

### BRIEF DESCRIPTION OF THE DRAWINGS

FIG. 1A is a perspective view of the device of the present invention in “Bar” mode;

FIG. 1B is a perspective view of the device of the present invention in “page” mode;

FIG. 2 is a box diagram of the device of the present invention;

FIG. 3 is a perspective view of one preferred embodiment of the foot actuated input device within the device of the present invention

FIG. 4 is a perspective view of a first alternative embodiment of the foot actuated input device within the device of the present invention;

FIG. 5 is a perspective view of a second alternative embodiment of the foot actuated input device within the device f the present invention; and

FIG. 6 is a perspective view of a third alternative embodiment of the foot actuated input device within the device f the present invention.

### DETAILED DESCRIPTION OF THE PREFERRED EMBODIMENT

The apparatus of the present invention will now be illustrated by reference to the accompanying drawings. The versatile portable electronic sheet music device of the present invention has been assigned reference numeral 10. Other elements have been assigned the reference numerals referred to below.

The preferred embodiment of the present invention is a device 10 including a central processing unit 20, a memory device 30, display 40, foot actuator 50 and software 60.

Memory 30 stores a database of all musical scores that a musician needs to perform. In certain embodiments, the database is loaded by the user and in other embodiments the database is loaded by the manufacturer of the device 10, for example when the device is made.

Memory 30 may be manifested in a hard drive, a CD ROM, a removable flash drive, or any other digital storage device or combination of digital storage devices. In the preferred embodiment, memory storage capacity is sufficient to store tens of thousands of musical scores. This memory, among other things, stores an index of the musical scores.

The index includes a cross-reference to a simple code with a particular composer and a particular musical score by said composer. For example, the code for a certain musical piece may have an index number 7-05. The number “7” may stand for composer number 7 which in our example is Beethoven. Thus, the number 7 corresponds to the folder with musical notes of Beethoven's music. The reference “05” may represent Beethoven's Fifth Symphony. The code does not have to be limited to numeric characters and may be alpha-numeric, entirely alphabetical, consist of full name and title of the piece, or contain any combination of these or other identifiers. Thus Beethoven's Fifth symphony may be designated by the user as “7-05”, “B5”, “BE-5”, “Beth5”, “Fifth”, “Bethoven's Fifth” or in any convenient and logical way. In the preferred embodiment, each musical piece is further subcoded with page number and/or bar number. Entering the number 7-05-02 will open Beethoven's Fifth Symphony and automatically display bar number two or page number two, depending on user-defined presets.

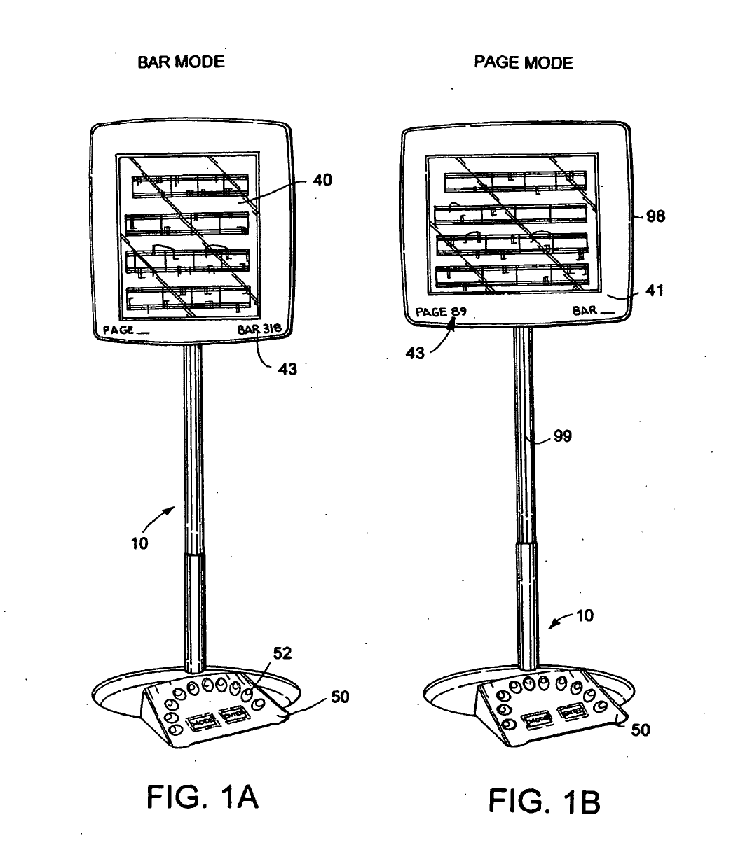

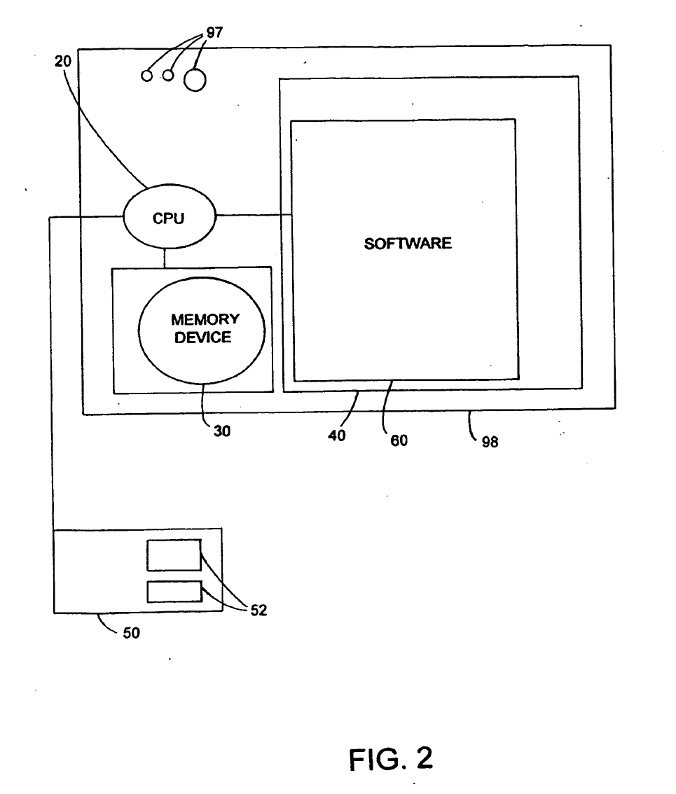

As shown in FIGS. 1A and 1B, the display 40 can present a screen showing the musical score in both “Portrait” or Landscape formats. FIG. 1A shows the score in Bar mode. This means that the display 40 screen displays a single musical bar at a time, or that it arranges the score in terms of musical bars. The identity of the bar 43 is automatically displayed on the lower portion of the display, preferably on the outside border 41 of the display 40. FIG. 1A is in “Portrait” format. FIG. 1B shows the musical score in Page mode which means that the screen is defined as a page of music. FIG. 1B is in Landscape format. The particular page 43 shown is automatically displayed on the lower portion of the display 40, preferably on the outer border 41 of said display. There need not be any connection between the mode (bar or page) and the format (Portrait or Landscape).

The codes, settings, and other information are entered into the device 10 through the use of input devices, including foot actuated input device 50, which is also referred to as foot actuator 50. Since the whole purpose of the device 10 is to allow the musician to avoid using his hands during a performance or rehearsal to turn pages of sheet music which would be time-consuming and/or noisy, in the preferred embodiment of the present invention the input device of device 10 is the foot-actuated input device 50 (also called a foot actuator).

In certain preferred embodiments, the input devices may comprise the foot actuator 50 alone or a combination of the foot actuator 50 with other input devices well known to those skilled in the art. Although common examples of such input devices include a computer keyboard, a mouse, a touch-screen, a microphone, buttons on the body of the device 10, etc., any input device that requires use of the musician's hands would not be used herein except for limited purposes. A microphone, in contrast, can be used to input commands without requiring the use of the musician's hands since it digitalizes sounds generated by the musician's mouth whereupon software can interpret the sounds.

The foot actuator 50 is uniquely suited for use with the device 10. The foot actuator 50 is capable of communicating to the central processing unit 20 an identity of any musical piece, bar and/or any page of the notes of the musical score, without requiring the use of musician's hands. All information, including a musical bar and/or any page of the notes of the musical score, and also including a simple code identifying a musical score and its composer can be input using only musician's feet.

The foot actuator 50 comprises an at least one pedal 52. In a preferred embodiment there are a series of pedals 52. The at least one pedal 52 allows inputting of any of at least ten alphanumeric characters 53, an “Enter” input signal and a “Mode” selection for choosing between a bar mode, a page mode, or any other modes. In the preferred embodiment, the pedals with characters contain alphabetical characters in addition to numerical ones in the format of a touch-tone telephone pad.

In an alternative embodiment of the present invention, the musician may prefer to remember and associate Beethoven with letter “B” pedal,” rather than the digit “2” pedal. If a large number of composers is stored in the database, several numbers and/or letters may be used to identify and distinguish each composer. In such circumstances, it may be easier to remember that pedal combination “B” and “E” stands for Beethoven, while “B” and “A” combination stand for Bach, rather than memorizing associated numbers.

It should be understood that the term “characters” as used herein to refer to the characters 53 on pedals 52 is a broad term intended to mean not only alpha numeric characters but also other graphic images or icons.

It should also be understood that the term “pedal” as used herein to refer to the pedals of at least one pedal 52 is a broad term intended to encompass numerous varieties and arrangements of simple and complex foot actuated input devices, some examples of which are described below.

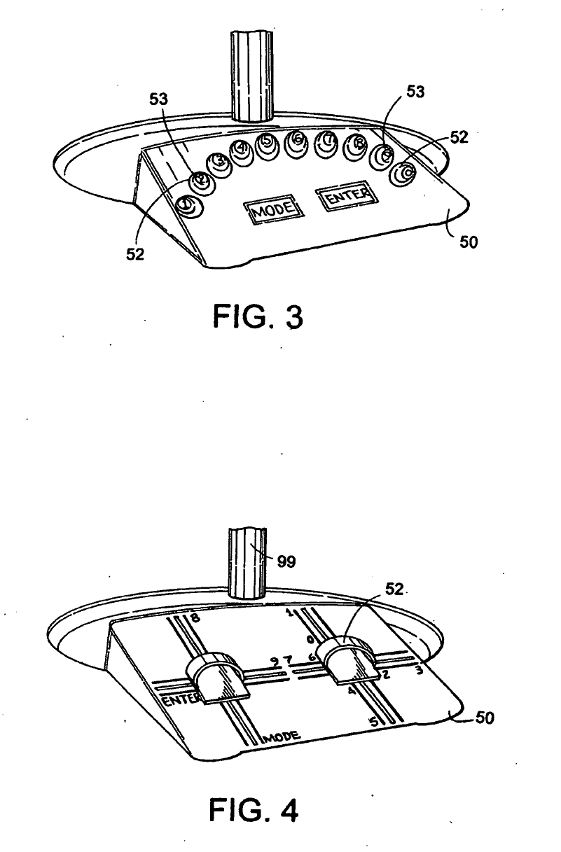

In one of the preferred embodiments of the present invention, where only the numeric codes are used to define the musical piece and the bar number, pedals of the simplest kind can be used. That is, each pedal in each mode stands in for a number or a letter. There is a pedal associated with “0”, a pedal associated with “2”, with “3,” and so on, up to “9,” and pedals associated with “Mode” and “Enter.” In this embodiment the numbers or letters associated with the pedal are labeled on the pedal itself. As shown in FIG. 3, in a preferred embodiment, the series of pedals are arranged in a semicircle forming part of foot actuator 50.

As seen in FIG. 3, in order to maximize the ease with which the musician's foot can press any of the pedals arranged in a semicircle, the pedals have convex upper surfaces 54 that make accessing them with one's foot easier. Moreover, in certain embodiments, the pedals are configured in three dimensional space like that of a stadium that has its deeper rows positioned higher up from the ground.

Although in theory the number of pedals is not limited and may exceed twelve, it should be appreciated that in a preferred embodiment, the number should be small enough to be convenient to input. Foot actuator 50 can include separate pedals for each alphabetical character, one or two pedals for browsing through the pages, and/or a pedal associated with favorite musical pieces or macro commands.

In the preferred embodiment, the portable size of the device 10 and the ease of use of the pedals is enhanced by the ergonomic placement of pedals in three-dimensional space, as shown in FIG. 3. The placement of pedals is such that they do not interfere with each other, are visible to the user, and both feet of the musician may be used for entering information. To achieve this, some pedals may be placed to the left of the device stand 99, while other pedals are placed to the right of the device stand 99. Such pedals would be intended to be used correspondingly with the user's left and right foot. To facilitate quick instinctive recognition of the pedals, some of the pedals may be higher than others, or painted in different color. Some commonly used pedals may be placed closer to the user, providing for effortless access. Pedals, further from the center may be angled toward the performer for better access and visibility.

Pedals can be placed at several levels. Some of the pedals may be mounted on the sides of the device stand 99. It should be understood that the term “foot actuated” is a broad term that includes actuation by other portions of person's leg, such as the knees. In certain embodiments, therefore, such pedals, if they are mounted at sufficient height may be conveniently activated not just by the feet, but by the knees of the performer.

To enhance visibility of the foot actuated input device 50 in low-lighting conditions, fluorescent paint may be used on the pedals 52, or electrical light sources may be built into the pedals or into the base of device stand 99.

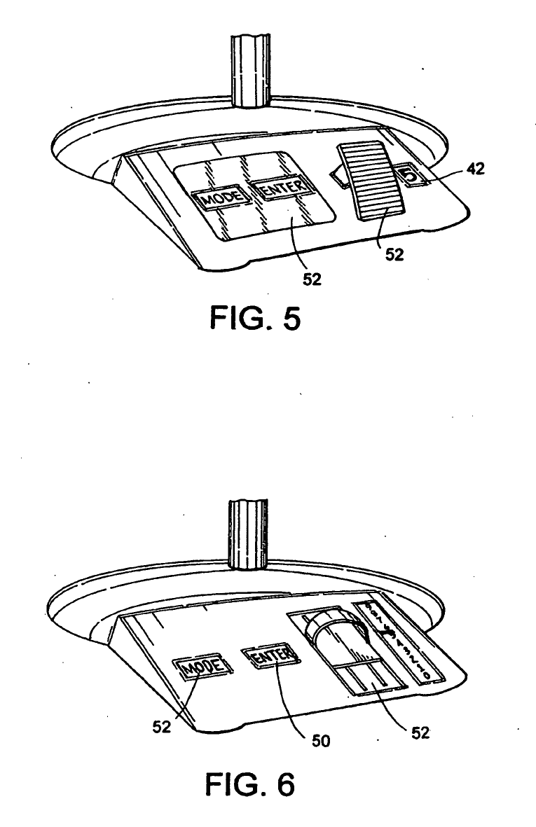

Other pedal designs may be used in conjunction with or as a replacement for simple pedals described above. For example, one pedal may perform multiple functions. As shown in FIG. 5, in one embodiment of the present invention, a pedal similar to a car's gas pedal is used to input parts of the code instead of using ten single-digit pedals. The longer period of time and/or the further down that such pedal is depressed, the larger is the number dialed. The number entered is displayed on a sheet music device's display 40 or a special gauge monitor 42, which may be mounted on or adjacent to the foot actuator 50. Corrections or fine tuning of characters may be made by one or two follow-up clicks or by a second pedal. Once the user is satisfied with the number gauged with the car-gas-type pedal, he may enter it using a separate “enter” pedal or a special button or click combination of the car-gas-type pedal.

In other preferred embodiments, each pedal of the at least one pedal can move to multiple positions. In order to accomplish having the musician's foot conveniently move the pedal in various directions, the pedal 52 of the at least one pedal of actuator 50 can be a partially enclosed pedal as in a shoe. In this case, the positions that the pedal can move to are associated with a character. In one preferred embodiment, similar to the handle for car's manual gear transmission, a pedal may be moved along a linear path to reach one of four (or more) predetermined positions. This is illustrated in FIG. 4. The paths may be right, left, forward and backward. Up and down directions or different parallel plains may be used to expand the functionality of such pedal. Each path/position of the pedal is associated with a character. Move forward may indicate “1.” Two moves forward—“2.” One move to the left indicates “3,” two moves to the left indicates “4”, etc.

In another embodiment shown in FIG. 6, a pedal may be moved by the foot of the musician along a straight segment marked with numbers from 1-10. Whenever a marker 43 moved by the movement of the pedal 52 is next to the desired number, the “enter” pedal is depressed to confirm the selection. “Enter” may be entered using a second pedal by the other foot or by the same foot.

Another example of a multipurpose pedal that may be used in device 10 is a circular dial pedal. The alpha-numeric characters are marked on the edges of the dial, much like on the face of the clock. Alternatively, as the musician moves his foot along the edge of the dial, the numbers associated with that portion of the dial are displayed on the display 40. To enter a character, the user depresses with his foot the edge of the dial that is associated with the character. In such a pedal, the “enter” input may be located in the center of the dial.

In yet another embodiment of the present invention, the pedal is not limited in its range of motion and acts much like a computer mouse. In this embodiment, a tracing arrow moves on display 40 as the musician moves the pedal along the floor. Possible selections, such as page numbers, bar numbers, mode button, fast-forward button, etc, may be displayed in the small section of display 40. To make a selection, the user just moves the pedal with his foot until the arrow on display 40 is over the required selection, and depresses the pedal. Such a pedal allows for limitless methods of search and navigation through sheet music (limited only by software options) without requiring the use of musician's hands.

Whenever the information is entered using the foot actuator 50 or one of the other input devices such as a touch screen or microphone, the information is processed by the device 10. In a process well known to those skilled in the art of personal computers and electronic devices, the information processing in the device 10 is performed by the central processing unit 20, in accordance with the algorithms programmed into the device's software 60. That is, the code entered by the user into the device 10 is recognized and associated with a particular page of a particular musical piece. The musical piece is then either directly retrieved from device's memory 30 or is downloaded from the internet database. The software 60 then displays the requested electronic sheet music on the screen. The delay between the user's act of entering the code and the display of the selected musical notes of the screen is almost imperceptible to the user.

The device 10 includes a flat-screen, wide angle visibility display 40, utilizing a technology such as TFT, or any other technology permitting visibility outdoors. The brightness of the display 40 is sufficient to allow high-contrast, effective visibility outdoors, including when the sun is out. The display 40 is mounted on adjustable-height, adjustable-tilt stand 99, allowing the musician to acquire the best viewing angle. In the preferred embodiment, the TFT display is an integral part of the device 10, thus providing for convenient transport and storage of the device 10.

The overall portability of the device 10 is further enhanced by the stand 99 being detachable from the part of device 10 that comprises the display 40. In the preferred embodiment, the stand 99 is adjustable in height by virtue of its ability to telescope within its longitudinal axis. This accommodates musicians of various heights as well as different sitting positions of a musician. In disassembled state, when sections of stand 99 are compactly stored within each other, the length of the stand is approximately one foot. Such a short length of the stand 99 makes the device 10 conveniently transportable inside of a suitcase.

The overall display/monitor structure 98 of device 10 not only includes display 40 but also houses the central processing unit 20, memory 30 such as in a hard drive bay, and software 60. The display/monitor structure 98 which can include various optional functional features 97 such as security key, start menu, journal, keyboard, power LED, hard drive LED, battery charge status LED, microphone, power ON/OFF, rotation, escape, function key, enter, directional keys, built in stereo speakers on the front of the border around display 40 on the front of the monitor/display structure 98. On the rear, it can include other well known options such as memory expansion slot, mini VGA port, USB port, microphone IN jack, audio OUT jack, modem port, fast Ethernet port, reset button, hard drive bay, battery pack and associated latch. The top of the display structure can have a security slot, a firewire port, a USB port, ventilation grills, PC card slot, Compact flash card slot and active stylus holder. The bottom can have a power jack (DC-IN) and a docking port. None of these elements are required for the device or method of the present invention, unless otherwise mentioned herein. They are merely additional optional functions that make the device 10 more versatile and practical. However, to the extent that they require use of the musician's hands during a performance or rehearsal, they would not be used in a preferred embodiment.

In one of the preferred embodiments of the present invention, one of the input devices is a microphone 46. The microphone 46 is associated with software voice recognition system 48 on the device 10. This system is intended and may be specifically tuned for recognizing musician's oral pronunciation of the names of composers, musical pieces and bar numbers, as well as above-mentioned codes and subcodes, identifying a musical piece. Thus, whenever musician says “Beethoven's Fifth” or “Open Beethoven's Fifth,” or “7-05,” the proper musical notes are displayed. To avoid the voice recognition system from accepting unintentional commands, the system may be tuned to respond only to the musician's individual voice. Similarly, to prevent accidental input of unintentional voice commands, the voice recognition system 48 may be set to only accept commands when a particular pedal of the foot actuator 50 is pressed.

The versatility of the device 10 may be further enhanced if it incorporates means for internet access. Internet access would allow the musician instant access to large online databases of electronic music scores. In the preferred embodiment, the means of internet access include a modem for connecting over the standard phone lines, ethernet port for broadband connection and wireless internet capability. This way, if the musical piece requested by user is not in the memory device 30, it can be automatically retrieved from the internet database and displayed on the screen within seconds. Wireless internet capability allows such downloading even if the musician is performing in a park. Additionally, wireless internet connectivity of device 10 allows for simple and instant networking of several devices of the present invention for orchestral performance. It also allows for networking devices of musicians thousands of miles away from each other, as may be useful for performing at simultaneously-held memorial ceremonies.

It is to be understood that while the apparatus and method of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A versatile and portable electronic sheet music device with an improved navigation system, comprising:
a memory, the memory having a storage capability for storing all musical scores that a musician needs to perform and for storing an index of said musical scores, the index including a cross-reference to a simple code with a particular composer and a particular musical score by said composer,
a wide angle visibility display that allows effective visibility indoors and outdoors, the display capable of displaying the notes of a musical score, said notes arranged by musical bar and/or by page,
a central processing unit that receives information from an input device and from a foot actuator, touch-screen, and/or a microphone, processes said information and communicates the output information to the display,
the foot actuated input device comprising at least one pedal that allows inputting of any of at least ten characters, an “Enter” input signal and a “Mode” selection for choosing between a bar mode and a page mode, the foot actuated input device capable of communicating to the central processing unit a received input, the received inputs representing a musical bar and/or any page of the notes of the musical score, and also including a simple code identifying a musical score and its composer, the at least one pedal operable by one or two feet of a person,
software for operating the central processing unit, the display and the memory, and
the display displaying the bar and/or page immediately when the foot actuator communicates said identity to the central processing unit.

2. The device of claim 1, wherein each pedal of the at least one pedal has a character labeled on said pedal.

3. The device of claim 1, wherein each pedal of the at least one pedal can move to a position and wherein the position is associated with a character.

4. The device of claim 3, wherein the character that a position is associated with is displayed on a visual screen when said pedal is moved to said position.

5. The device of claim 4, wherein the visual screen is located on the display

6. The device of claim 4, wherein the screen is on or adjacent to the foot actuator

7. The device of claim 1, wherein a first pedal of the at least one pedal can move to a position associated with a character and wherein a second pedal of the at least one pedal can move to a position associated with a Mode or Enter function.

8. The device of claim 2, wherein the characters are a collection of ten decimal digits “0” through “9”.

9. The device of claim 8, wherein the series of pedals comprise twelve pedals including ten pedals for each of the ten decimal digits, an “Enter” pedal and a “Mode” pedal.

10. The device of claim 3, wherein the pedals of the foot actuated input device are arranged on several different levels of height.

11. The device of claim 1, wherein the display is a touch screen.

12. The device of claim 1, including a microphone that forms part of a voice recognition system for recognizing musician's oral pronunciation of the names of composers, musical pieces, bar numbers and codes identifying a musical piece.

13. The device of claim 1, including an accessory that provides wireless internet access.

14. The device of claim 1, comprising a height-adjustable telescopic stand attached to the display and to the foot actuated input device.

15. A method of navigating through sheet music, comprising:
(a) providing a electronic sheet music device comprising
a memory, the memory capable of storing all musical scores that a musician needs to perform and capable of storing an index of said musical scores, the index including a cross-reference to a simple code with a particular composer and a particular musical score by said composer,
a wide angle visibility display that allows effective visibility indoors and outdoors, the display capable of displaying the notes of a musical score, said notes arranged by musical bar and/or by page,
a central processing unit that receives information from an input device and from a foot actuator, touch-screen, and/or a microphone, processes said information and communicates the output information to the display,
the foot actuated input device comprising at least one pedal that allows inputting of any of at least ten characters, an “Enter” input signal and a “Mode” selection for choosing between a bar mode and a page mode, the foot actuated input device capable of communicating to the central processing unit a received input, the received inputs representing a musical bar and/or any page of the notes of the musical score, and also including a simple code identifying a musical score and its composer, the at least one pedal operable by one or two feet of a person,
software for operating the central processing unit, the display and the memory, and
the display displaying the bar and/or page immediately when the foot actuator communicates said identity to the central processing unit,
(b) loading a database of musical scores,
(c) navigating through the musical score using only the foot actuated input device by inputting a musical bar number and/or a musical page number.

16. The method of claim 15, wherein each pedal of the at least one pedal has a character labeled on said pedal.

17. The method of claim 15, wherein each pedal of the at least one pedal can move to a position and wherein the position is associated with a character.

18. A method of navigating through sheet music, comprising:
(a) providing an electronic sheet music device comprising
a memory, the memory having a storage of all musical scores that a musician needs to perform and a storage of an index of said musical scores, the index including a cross-reference to a simple code with a particular composer and a particular musical score by said composer,
a wide angle visibility display that allows effective visibility indoors and outdoors, the display capable of displaying the notes of a musical score, said notes arranged by musical bar and/or by page,
a central processing unit that receives information from an input device and from a foot actuator, touch-screen, and/or a microphone, processes said information and communicates the output information to the display,
the foot actuated input device comprising at least one pedal that allows inputting of any of at least ten characters, an “Enter” input signal and a “Mode” selection for choosing between a bar mode and a page mode, the foot actuated input device capable of communicating to the central processing unit a received input, the received inputs representing a musical bar and/or any page of the notes of the musical score, and also including a simple code identifying a musical score and its composer, the at least one pedal operable by one or two feet of a person,
software for operating the central processing unit, the display and the memory, and
the display displaying the bar and/or page immediately when the foot actuator communicates said identity to the central processing unit,
(b) navigating through the musical score using only the foot actuated input device by inputting a musical bar number and/or a musical page number.

19. The method of claim 18, wherein each pedal of the at least one pedal has a character labeled on said pedal.

20. The method of claim 18, wherein each pedal of the at least one pedal can move to a position and wherein the position is associated with a character.
